(19) United States
(12) Patent Application Publication
(10) Pub. No.: US 2026/0169681 A1
(43) Pub. Date: Jun. 18, 2026

(54) ADJUSTMENT APPARATUS AND STORAGE MEDIUM

(71) Applicant: AZSTOKE CO., LTD., Tokyo (JP)

(72) Inventor: Kentaro Nakashima, Tokyo (JP)

(73) Assignee: AZSTOKE CO., LTD., Tokyo (JP)

(21) Appl. No.: 19/530,481

(22) Filed: Feb. 5, 2026

Related U.S. Application Data
(63) Continuation of application No. PCT/JP2024/022127, filed on Jun. 18, 2024.

(30) Foreign Application Priority Data
Aug. 8, 2023 (JP) 2023-129498

(51) Int. Cl. G06F 3/16

(52) U.S. Cl. CPC G06F 3/165

(57) ABSTRACT

An adjustment apparatus for adjusting a signal level of an audio signal formed from a plurality of frames recorded in a file at discrete adjustment points corresponding to an envelope of the audio signal is provided. The apparatus includes a processor, and a memory. The processor is configured to function as an acquisition unit that acquires the envelope of the audio signal, and an adjustment unit that adjusts the envelope. The adjustment unit detects a peak value of the envelope for each frame, calculates a first average value as an average value of the detected peak values in the plurality of frames, calculates a second average value as an average value of peak values higher than the first average value, and adjusts the envelope so as to suppress at least some of peak values higher than the second average value.

### CROSS-REFERENCE TO RELATED APPLICATION(S)

This application is a continuation of International Patent Application No. PCT/JP2024/022127 filed on Jun. 18, 2024, which claims priority to and the benefit of Japanese Patent Application No. 2023-129498 filed on Aug. 8, 2023, the entire disclosures of which are incorporated herein by reference.

### BACKGROUND OF THE INVENTION

### Field of the Invention

The present invention relates to an adjustment apparatus and a storage medium.

### Description of the Related Art

The dynamic range of an audio signal may be wider than that of an output device such as a loudspeaker. In this case, the user cannot hear a part of an audio signal where the signal level is low, and a part of the audio signal where the signal level is high may be clipped. Therefore, it is necessary to appropriately compress the dynamic range of the audio signal. Processing of compressing the dynamic range is called dynamic range compression (or simply compression), and an adjustment apparatus that performs compression is called a compressor.

PTL 1 discloses a technique of automatically adjusting the signal level using the average power level and the maximum power level of the signal level of an audio signal.

### CITATION LIST

### Patent Literature

PTL 1: Japanese Patent Laid-Open No. 2001-103593

Presently, automatic adjustment of the signal level is uniformly performed on a track basis, and is not performed on a waveform basis. Therefore, the result of automatic adjustment of the signal level is not always satisfactory, and the user finally needs to perform manual adjustment on a waveform basis, which requires much labor for manual adjustment. It is desired to improve automatic adjustment of the signal level.

### SUMMARY OF THE INVENTION

The present invention provides a technique for automatic adjustment of the signal level advantageous in reducing the labor of the user for manual adjustment.

The present invention in one aspect provides an adjustment apparatus for adjusting a signal level of an audio signal formed from a plurality of frames recorded in a file at discrete adjustment points corresponding to an envelope of the audio signal, the apparatus including a processor, and a memory, wherein the processor is configured to function as an acquisition unit configured to acquire the envelope of the audio signal, and an adjustment unit configured to adjust the envelope, wherein the adjustment unit is configured to detect a peak value of the envelope for each frame, calculate a first average value as an average value of the detected peak values in the plurality of frames, calculate a second average value as an average value of peak values higher than the first average value, and adjust the envelope so as to suppress at least some of peak values higher than the second average value.

Other features and advantages of the present invention will be apparent from the following description taken in conjunction with the accompanying drawings. Note that the same reference numerals denote the same or like components throughout the accompanying drawings.

### BRIEF DESCRIPTION OF THE DRAWINGS

The accompanying drawings, which are incorporated in and constitute a part of the specification, illustrate embodiments of the invention and, together with the description, serve to explain principles of the invention.

FIG. 1 is a block diagram showing the configuration of an adjustment apparatus according to an embodiment.

FIG. 2 is a view exemplifying the waveform of an audio signal.

FIG. 3 is a view exemplifying the waveform of the audio signal and adjustment points.

FIG. 4 is a flowchart of adjustment processing of the signal level of the audio signal.

FIG. 5 is a flowchart of the adjustment processing of the signal level of the audio signal.

FIG. 6 is a flowchart of the adjustment processing of the signal level of the audio signal.

FIG. 7 is a view exemplifying a waveform and adjustment points after performing automatic adjustment of the signal level.

FIG. 8 is a view exemplifying the waveforms of audio signals of a plurality of files and adjustment points.

### DESCRIPTION OF THE EMBODIMENTS

Hereinafter, embodiments will be described in detail with reference to the attached drawings. Note, the following embodiments are not intended to limit the scope of the claimed invention, and limitation is not made to an invention that requires a combination of all features described in the embodiments. Two or more of the multiple features described in the embodiments may be combined as appropriate. Furthermore, the same reference numerals are given to the same or similar configurations, and redundant description thereof is omitted.

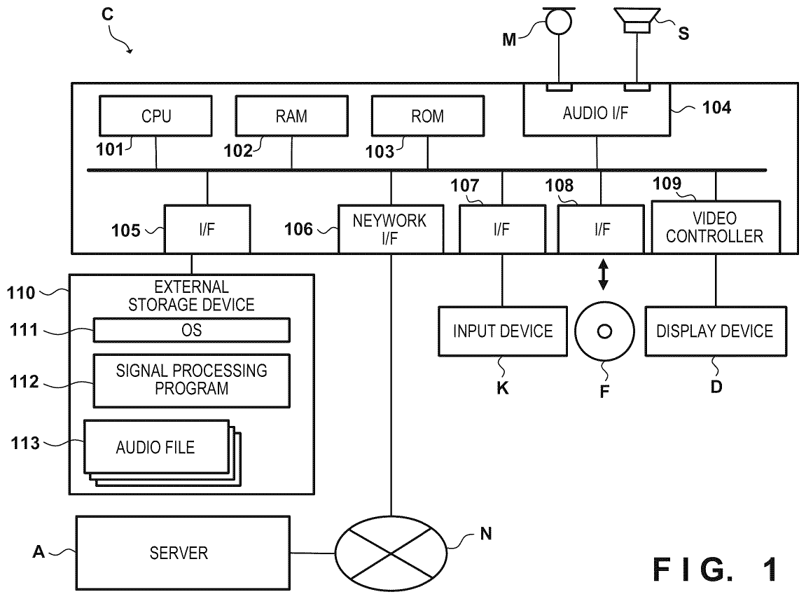

FIG. 1 is a block diagram showing the configuration of an adjustment apparatus C according to an embodiment. The adjustment apparatus C is an apparatus that adjusts the signal level of an audio signal formed from a plurality of frames recorded in a file at discrete adjustment points corresponding to the envelope of the audio signal.

The adjustment apparatus C can be a computer apparatus such as a personal computer or a workstation. The adjustment apparatus C includes a central processing unit (CPU) 101 that controls the entire apparatus, a RAM 102 that functions as a main storage device and provides a work area of the CPU 101, and a ROM 103 that stores permanent data and programs. The adjustment apparatus C also includes an audio interface (I/F) 104. A microphone M and a loudspeaker S can be connected to the audio interface 104. An external storage device 110 is connected to the adjustment apparatus C via an interface (I/F) 105. The external storage device 110 can be, for example, a hard disk drive (HDD), a solid-state drive (SSD), or a combination thereof. Note that the external storage device 110 may be formed as a secondary storage device in the adjustment apparatus C. A network interface 106 is connected to a network N to perform communication. The adjustment apparatus C can communicably be connected to a server A via, for example, the network N.

An input device such as a keyboard and a mouse can be connected to the adjustment apparatus C via an interface 107. An external media device F such as a CD-ROM drive or a DVD drive can be connected to the adjustment apparatus C via an interface 108. Furthermore, the adjustment apparatus C includes a video controller 109. The video controller 109 controls image display on a display device D.

A boot program for activating the adjustment apparatus C is stored in the ROM 103. As shown in FIG. 1, an operating system (OS) 111 as well as a signal processing program 112 for performing audio signal processing and one or more audio files 113 can be installed in the external storage device 110. The audio file 113 may be supplied from an external apparatus such as the server A via the network N, or supplied from a medium accommodated in the external media device F. Alternatively, the audio file 113 may be created from sound collected by the microphone M.

In an example, the file format of the audio file 113 can be a WAVE file format generally used in a personal computer. A WAVE file can include a header including information such as a monaural/stereo type, a sampling frequency, and the number of quantization bits, and audio signal data. Note that the file format of the audio file 113 is not limited to the WAVE file format. The file format of the audio file 113 may be a format other than the WAVE file format, such as the AIFF, MP3, or AAC formats.

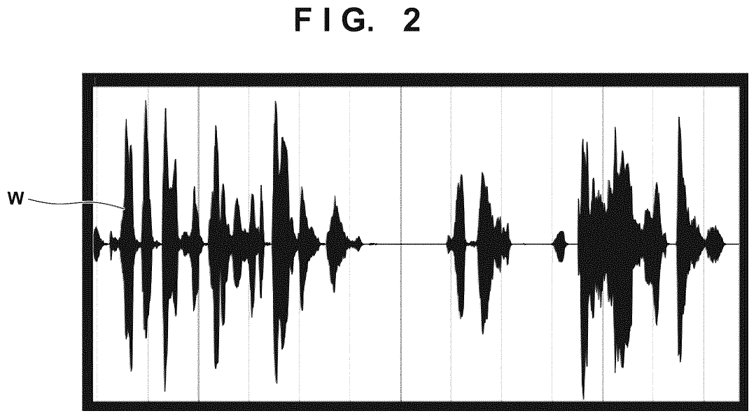

FIG. 2 shows an example of a waveform W of the whole section of the audio signal displayed on the display device D when the CPU 101 executes the signal processing program 112 to load the audio file 113 as a processing target. The displayed waveform W is a time domain waveform, the abscissa represents the time, and the ordinate represents the signal level.

In an example, to compress the audio signal, an envelope indicating the outline of the waveform W of the audio signal can be acquired. The adjustment apparatus C serving as an adjustment apparatus can set adjustment points at a plurality of discrete positions corresponding to the envelope.

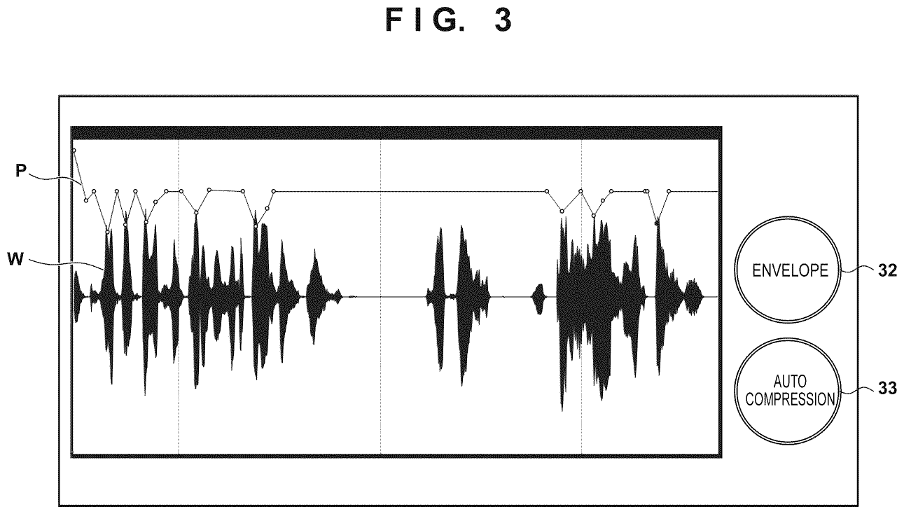

FIG. 3 shows examples of the waveform W and the adjustment points P corresponding to the envelope. When the user clicks an envelope button 32 with the mouse, envelope generation processing for the waveform W is executed. An envelope indicates the outline of the waveform, and is obtained by connecting the respective peaks of the waveform. The audio signal may undergo full-wave rectification, thereby obtaining the envelope of the audio signal having undergone full-wave rectification. After that, an envelope curve representing the envelope generated by the envelope generation processing is displayed. The user can adjust the envelope curve by adding or moving the adjustment points P corresponding to the envelope curve. For example, the user can drag an arbitrary adjustment point P with the mouse, thereby adjusting the signal level at this position. The waveform W may be re-rendered in accordance with the adjusted signal level. When the user clicks an auto compression button 33, automatic adjustment (auto compression) of the signal level is performed (automatic adjustment mode). Note that in the example shown in FIG. 3, a GUI including the envelope button 32 and the auto compression button 33 is provided. However, instead of this, a GUI in which a pull-down menu is provided and an envelope or auto compression function can be selected from the pull-down menu may be provided.

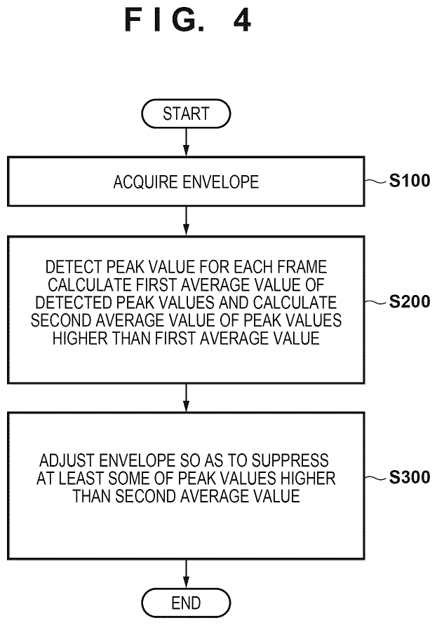

FIG. 4 is a flowchart of adjustment processing of adjusting the signal level of the audio signal by the adjustment apparatus C. A program corresponding to this flowchart is included in the signal processing program 112, and is executed by the CPU 101.

In step S100, the CPU 101 acquires the entire envelope (the envelope of the whole section) of the audio signal formed from the plurality of frames included in the audio file loaded as a processing target. This processing may automatically be performed when the auto compression button 33 is clicked, or may be performed when the envelope button 32 is clicked. In this embodiment, subsequent processing is performed for the acquired envelope.

In step S200, the CPU 101 detects the peak value of the envelope for each frame. The frame is a waveform unit obtained by dividing the waveform of the audio signal (envelope) into segments of a predetermined time length. The time length of one frame can be, for example, 10 ms. After that, the CPU 101 calculates the average value (first average value) of the peak values detected in the entire audio signal (that is, all frames). Next, the CPU 101 calculates the average value (second average value) of the peak values higher than the first average value.

In step S300, the CPU 101 adjusts the envelope so as to suppress at least some of the peak values higher than the second average value.

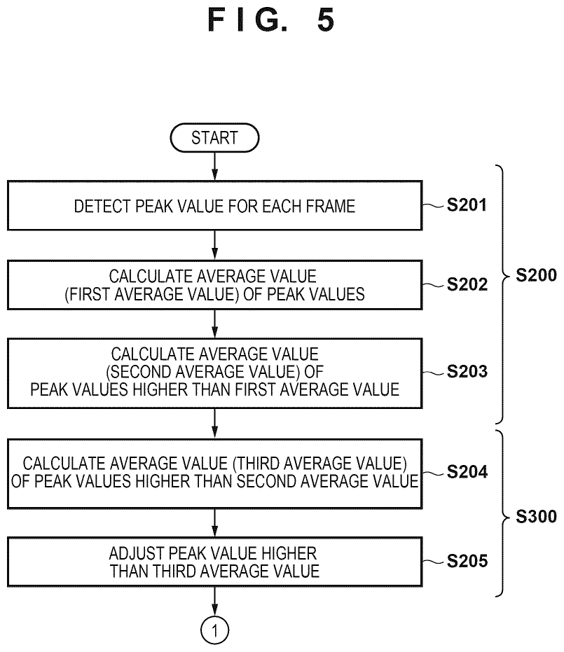

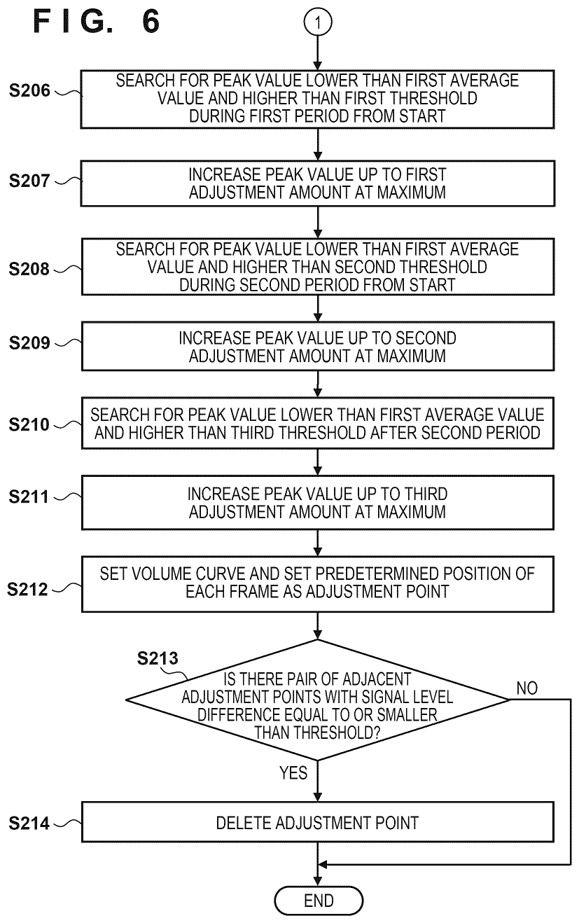

The detailed procedure of steps S200 and S300 will be described with reference to FIGS. 5 and 6.

Step S200 includes steps S201 to S203 below. In step S201, the CPU 101 detects the peak value of the envelope for each frame. As described above, the frame is a waveform unit obtained by dividing the waveform of the audio signal (envelope) into segments of the predetermined time length, and the length of one frame can be, for example, 10 ms. In an example, one frame may further be divided into sub-frames of a predetermined time length (for example, 1 ms), the peak value may be detected for each sub-frame, and the maximum value of the peak values in one frame may be obtained, thereby detecting the peak value of the frame.

In step S202, the CPU 101 calculates the average value (first average value) of the peak values detected in the entire audio signal (envelope) (that is, all frames). The first average value can represent a dominant volume in the audio signal. The peaks exceeding the first average value act in a direction of widening the dynamic range. The peaks exceeding the first average value may include a sudden peak that unnecessarily widens the dynamic range. In the following processing, such a sudden peak is detected to suppress its signal level. In step S203, the CPU 101 detects the peak values higher than the first average value, and calculates the average value (second average value) of the detected peak values.

Step S300 includes steps S204 and S205 below. In step S204, the CPU 101 detects the peak values higher than the second average value and calculates the average value (third average value) of the detected peak values. The peak exceeding the third average value is determined as a sudden peak that excessively widens the dynamic range. To cope with this, in step S205, the CPU 101 adjusts the peak value higher than the third average value to be closer to the third average value. In an example, the CPU 101 adjusts the peak value higher than the third average value to the third average value. In another example, the CPU 101 can adjust the peak value higher than the third average value to an adjustment value preset by the user. For example, the CPU 101 detects the peak values higher than the third average value, and calculates the average value (fourth average value) of the detected peak values. Then, the adjustment value may be set to a value between the third average value and the fourth average value. In this case, the adjustment value preset by the user may be indicated by, for example, a percentage by setting the third average value to 0% and the fourth average value to 100%.

Processing of allowing the user to easily hear a part with a low signal level is performed. In particular, in a section immediately after the start of the audio signal, an audible sound tends to be small. To cope with this, in step S206, the CPU 101 searches for the presence of the peak value of the envelope that is lower than the first average value and higher than the first threshold during the first period (for example, 0.1 sec) from the start of the audio signal. The first threshold is, for example, a predetermined value corresponding to a noise level. If there is such a peak value, the CPU 101 increases, in step S207, the signal level of the peak value up to the first adjustment amount (for example, 7 dB). Note that the first threshold and the first adjustment amount can arbitrarily be preset by the user.

Next, in step S208, the CPU 101 searches for the presence of the peak value of the envelope that is lower than the first average value and higher than the second threshold higher than the first threshold during the second period (for example, 0.2 sec), longer than the first period, from the start of the audio signal. If there is such a peak value, the CPU 101 increases, in step S209, the signal level of the peak value up to the second adjustment amount (for example, 4 dB) smaller than the first adjustment amount. Note that the second threshold and the second adjustment amount can arbitrarily be preset by the user.

Next, in step S210, the CPU 101 searches for the presence of the peak value of the envelope that is lower than the first average value and higher than the third threshold higher than the second threshold after the second period. If there is such a peak value, the CPU 101 increases, in step S211, the signal level of the peak value up to the third adjustment amount (for example, 2 dB) smaller than the second adjustment amount. Note that the third threshold and the third adjustment amount can arbitrarily be preset by the user.

With the above processing, appropriate dynamic range compression with excellent audibility is implemented.

With the above processing, the CPU 101 can adjust the signal level of the audio signal. The CPU 101 re-renders the waveform of the audio signal in accordance with the adjusted signal level. In step S212, the CPU 101 sets a volume curve corresponding to the envelope of the audio signal whose signal level has been adjusted, and sets, as an adjustment point, a predetermined position of each frame in the volume curve. The predetermined position of the frame can be set at, for example, the center of the frame. Alternatively, the predetermined position of the frame may be set at the start or end of the frame.

The adjustment point is a position where the user can arbitrarily perform manual adjustment by dragging with the mouse. There is no point in presenting adjacent adjustment points with almost no level difference. When the user performs fine adjustment for the output sound after automatic adjustment by hearing and confirming it, if the number of adjustment points is too large, it becomes difficult to perform fine adjustment. To cope with this, in step S213, the CPU 101 searches for a pair of adjacent adjustment points with a signal level difference equal to or smaller than a predetermined threshold (for example, 0.5 dB) among the plurality of adjustment points set in the volume curve of the audio signal after the signal level is adjusted based on a generated parameter. If there is such a pair, the CPU 101 deletes one adjustment point of the pair in step S214.

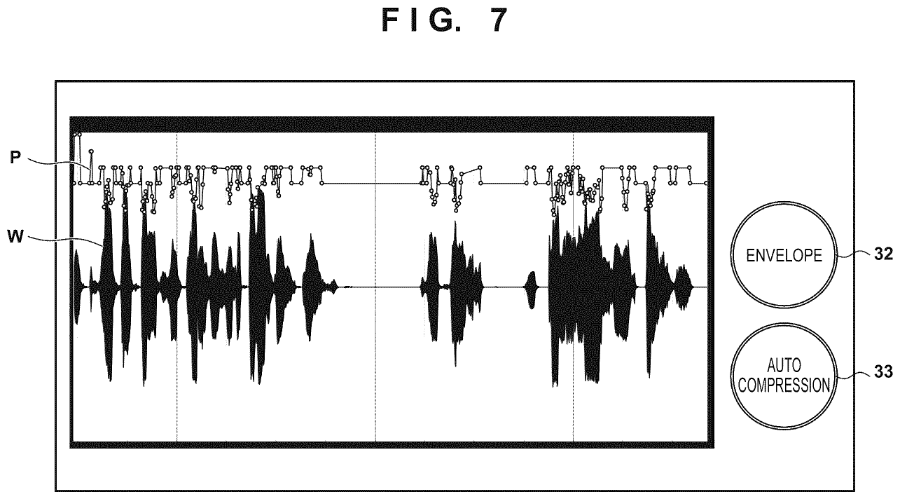

FIG. 7 shows examples of the waveform W and the adjustment points P after performing automatic adjustment of the signal level. By appropriate automatic adjustment of the signal level according to this embodiment, the labor of the user for manual adjustment is reduced.

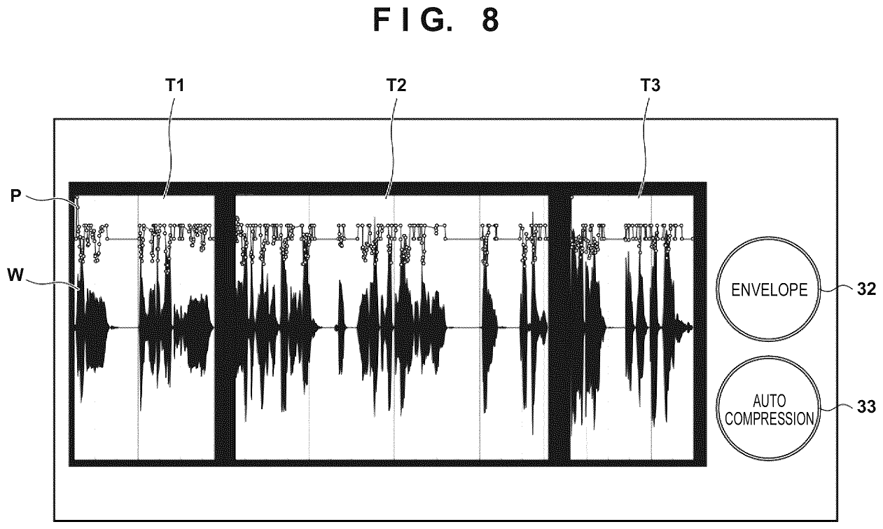

Note that in the examples of FIGS. 3 and 7, the audio signal recorded in one file loaded as a processing target is displayed, but a plurality of files may be loaded as processing targets in advance. FIG. 8 shows examples of the waveforms and the adjustment points of audio signals T1, T2, and T3 of a plurality of files loaded in advance. The user can cause the adjustment apparatus C to execute the above-described adjustment processing of the signal level by designating one of the audio signals T1, T2, and T3.

The present invention can also be implemented by causing the computer to execute a program for implementing the function of the adjustment apparatus described in the above embodiment.

According to the present invention, it is possible to provide a technique for automatic adjustment of the signal level advantageous in reducing the labor of the user for manual adjustment.

The invention is not limited to the foregoing embodiments, and various variations/changes are possible within the spirit of the invention.

What is claimed is:

1. An adjustment apparatus for adjusting a signal level of an audio signal formed from a plurality of frames recorded in a file at discrete adjustment points corresponding to an envelope of the audio signal, the apparatus comprising:
a processor; and
a memory,
wherein the processor is configured to function as:
an acquisition unit configured to acquire the envelope of the audio signal; and
an adjustment unit configured to adjust the envelope,
wherein the adjustment unit is configured to:
detect a peak value of the envelope for each frame,
calculate a first average value as an average value of the detected peak values in the plurality of frames,
calculate a second average value as an average value of peak values higher than the first average value, and
adjust the envelope so as to suppress at least some of peak values higher than the second average value.

2. The adjustment apparatus according to claim 1, wherein
the adjustment unit is further configured to
calculate a third average value as an average value of the peak values higher than the second average value among the detected peak values, and
adjust the envelope so that the signal levels of peak values higher than the third average value become closer to the third average value.

3. The adjustment apparatus according to claim 1, wherein
the adjustment unit is further configured to
calculate a third average value as an average value of the peak values higher than the second average value among the detected peak values,
calculate a fourth average value as an average value of peak values higher than the third average value, and
adjust the envelope so that the signal levels of the peak values higher than the third average value become values between the third average value and the fourth average value.

4. The adjustment apparatus according to claim 1, wherein in a case where there exists a peak value of the envelope that is lower than the first average value and higher than a first threshold during a first period from a start of the audio signal, the adjustment unit is further configured to increase the signal level of the peak value up to a first adjustment amount.

5. The adjustment apparatus according to claim 4, wherein the first threshold is a predetermined value corresponding to a noise level.

6. The adjustment apparatus according to claim 4, wherein in a case where there exists a peak value of the envelope that is lower than the first average value and higher than a second threshold higher than the first threshold during a second period, longer than the first period, from the start of the audio signal, the adjustment unit is further configured to increase the signal level of the peak value up to a second adjustment amount smaller than the first adjustment amount.

7. The adjustment apparatus according to claim 6, wherein in a case where there exists a peak value of the envelope that is lower than the first average value and higher than a third threshold higher than the second threshold after the second period, the adjustment unit is further configured to increase the signal level of the peak value up to a third adjustment amount smaller than the second adjustment amount.

8. The adjustment apparatus according to claim 1, wherein the adjustment unit is configured to set a predetermined position of each frame as an adjustment point.

9. The adjustment apparatus according to claim 8, wherein in a case where a signal level difference between two adjacent adjustment points of the audio signal obtained after the signal level is adjusted by the adjustment means is not larger than a predetermined threshold, the adjustment unit is configured to delete one of the two adjustment points.

10. A non-transitory computer-readable storage medium storing a program to be installed in a computer, wherein the program when executed by the computer causes the computer to function as:
an acquisition unit configured to acquire the envelope of the audio signal; and
an adjustment unit configured to adjust the envelope,
wherein the adjustment unit is configured to:
detect a peak value of the envelope for each frame,
calculate a first average value as an average value of the detected peak values in the plurality of frames,
calculate a second average value as an average value of peak values higher than the first average value, and
adjust the envelope so as to suppress at least some of peak values higher than the second average value.
